(19) United States
(12) Patent Application Publication
(10) Pub. No.: US 2013/0093910 A1
(43) Pub. Date: Apr. 18, 2013

(54) IMAGE SENSOR AND IMAGE PROCESSING APPARATUS INCLUDING THE SAME

(71) Applicants: Kwang Hyun LEE, Seongnam-si (KR); Hyeon Ho SONG, Seongnam-si (KR); Woon Phil YANG, Suwon-si (KR)

(72) Inventors: Kwang Hyun LEE, Seongnam-si (KR); Hyeon Ho SONG, Seongnam-si (KR); Woon Phil YANG, Suwon-si (KR)

(73) Assignee: SAMSUNG ELECTRONICS CO., LTD., Suwon-si (KR)

(21) Appl. No.: 13/617,898

(22) Filed: Sep. 14, 2012

(30) Foreign Application Priority Data
Oct. 14, 2011 (KR) 10-2011-0105284

(51) Int. Cl. H04N 5/225; H01L 27/146

(52) U.S. Cl. 348/222.1; 250/208.1; 348/E05.024

(57) ABSTRACT

An image sensor is disclosed. The image sensor includes a plurality of pixels, a plurality of transmission lines connected to each of the pixels, respectively, and a plurality of comparators configured to compare each of a plurality of control signals transmitted through each of the transmission lines with a reference signal and output a comparative signal based on the result of the comparison.

### CROSS-REFERENCE TO RELATED APPLICATION

This application claims priority under 35 U.S.C. §119(a) from Korean Patent Application No. 10-2011-0105284 filed on Oct. 14, 2010, the disclosure of which is hereby incorporated by reference in its entirety.

### BACKGROUND

Example embodiments of inventive concepts relates to an image sensor and/or an image processing apparatus.

Improvements in an image quality of an image sensor have developed in two ways. The first way to improve image quality is by increasing components per chip or degree of integration by reducing a size of a pixel. That is, the first way image quality has improved is by obtaining a higher resolution by integrating more pixels in a fixed size of an image sensor.

The second way to improve image quality is by increasing a signal-to-noise ratio (SNR) and a dynamic range. That is, the second way image quality has improved is by maintaining a constant pixel size while reducing noise.

In case of implementing an image sensor using a complementary metal oxide semiconductor (CMOS), research has been actively conducted using the first way, i.e., increasing the degree of integration by reducing a pixel size.

As more pixels are integrated into a fixed size CMOS image sensor, often problems, such as a signal line connection defect may occur more frequently. Therefore, as the number of pixels increase so too does the importance of detecting a defect of the CMOS image sensor.

Conventionally, a defect in a CMOS image sensor is detected by using image data captured by the CMOS image sensor.

### SUMMARY

The inventive concepts provides an image sensor including a plurality of pixels configured to be controlled by a plurality of control signals, a plurality of transmission lines connected to each of a plurality of pixels, respectively, and a plurality of comparators configured to compare each of a plurality of control signals transmitted through each of the transmission lines with a reference signal and output a comparative signal based on the result of the comparison.

The image sensor further includes a row driver configured to output each of the control signals, and the plurality of comparators are embodied at an opposite side of the row driver from a shift register.

The image sensor further includes a row driver configured to output each of the control signals and a plurality of switches connected between the transmission lines and the row driver.

The image sensor further includes a data converter configured to convert comparative signals output from the plurality of comparators into serial data. Each of the plurality of transmission lines is a column line configured to transmit a pixel signal output from the pixels.

Each comparator of the plurality of comparators is a current comparator.

Each control signal is one of a transmission control signal, reset signal, and select signal.

The image sensor further includes a plurality of latches and a plurality of selectors, a present selector among the plurality of selectors is configured to transmit one of an output signal of the previous latch among the plurality of latches to a next latch of the plurality of latches in response to a select signal, and a comparison signal output from the comparator corresponding to the present selector among the comparators into the next latch in response to the select signal.

The inventive concepts provide an image processing apparatus including an image sensor and a controller configured to control the image sensor. The image sensor includes a plurality of pixels each configured to be controlled by an associated control signal, a plurality of transmission lines each connected to an associated pixel and configured to transmit the associated control signal, and a plurality of comparators each configured to compare the associated control signal with a reference signal and output a comparative signal based on the result of the comparison.

Each of the plurality of transmission lines is a row line configured to transmit the associated control signal. The image sensor further includes a row driver configured to output the control signals, each control signal is one of a transmission control signal, reset signal, and select signal.

Each of the plurality of transmission lines is a column line configured to transmit pixel signals output from the pixels.

The image sensor further includes a shift register connected to an output terminal of each comparator of the plurality of comparators.

The image sensor further includes a plurality of latches and a plurality of selectors. A present selector among the plurality of selectors is configured to transmit one of an output signal from a previous latch among the plurality of latches to a next latch of the plurality of latches in response to a select signal, and a comparative signal output from the comparator corresponding to the present selector among the comparators into the next latch in response to the select signal.

The inventive concepts provides a portable communication device including the image processing apparatus, a processor configured to control an operation of the image processing apparatus, and a display configured to display a data output from the image processing apparatus.

### BRIEF DESCRIPTION OF THE DRAWINGS

These and/or other aspects and advantages of the inventive concepts will become apparent and more readily appreciated from the following description of the embodiments, taken in conjunction with the accompanying drawings of which:

FIG. 1 is a conceptual diagram of an image sensor test system according to an example embodiment of the inventive concepts;

FIG. 2 is a block diagram of the image sensor shown in FIG. 1 including a test circuit;

FIG. 3A is a partial schematic circuit diagram of an image sensor including an example embodiment of the test circuit shown in FIG. 2;

FIG. 3B is a partial schematic circuit diagram of an image sensor including another example embodiment of the test circuit shown in FIG. 2;

FIG. 3C is a partial schematic circuit diagram of an image sensor including yet another example embodiment of the test circuit shown in FIG. 2;

FIG. 4 is a circuit diagram according to an example embodiment of the pixels shown in FIG. 3A through 3C;

FIG. 5A is a partial schematic circuit diagram of an image sensor including an example embodiment of a comparator shown in FIG. 3A;

FIG. 5B is a partial schematic circuit diagram of image sensor including another example embodiment of a comparator shown in FIG. 3A;

FIG. 5C is a partial schematic circuit diagram of an image sensor including yet another example embodiment of one of the comparators shown in FIG. 3A;

FIG. 6 is a block diagram according to an example embodiment of a shift register shown in FIG. 3A;

FIG. 7 is a flow chart illustrating a method for testing an image sensor according to an example embodiment of the present invention;

FIG. 8 is a flow chart illustrating a method for testing an image sensor according to another example embodiment of the present invention;

FIG. 9 is a flow chart illustrating a method for testing an image sensor according to yet another example embodiment of the present invention; and

FIG. 10 is a block diagram of an image processing apparatus including the image sensor shown in FIG. 1.

### DETAILED DESCRIPTION

Example embodiments now will be described more fully hereinafter with reference to the accompanying drawings, in which example embodiments are shown. Example embodiments may, however, be embodied in many different forms and should not be construed as limited to the embodiments set forth herein. Rather, these example embodiments are provided so that this disclosure will be thorough and complete, and will fully convey the scope of example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

The term “compare” used herein is not restricted to comparing directly A with B. For example, comparing two signals (for example, currents) may denote not only comparing two signals themselves one to one but also comparing how each potential of a specific node varies with respect to each of the two signals.

In other words, the term “compare” used herein may denote comparing A with B indirectly.

The term “transmission line” used herein may include a row line and/or a column line. The transmission signal used herein may denote a control signal configured to control each of a plurality of pixels included in an image sensor, a pixel signal output from each of the plurality of pixels, and a test signal provided for a test.

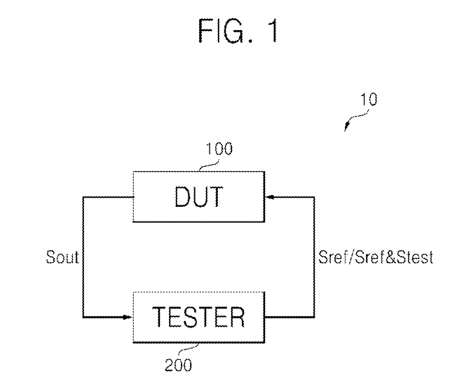

FIG. 1 is a conceptual diagram of an image sensor test system according to an example embodiment of the present invention. Referring to FIG. 1, the image sensor test system 10 includes an image sensor 100 and a tester 200.

The image sensor 100 is a device under test (DUT) that is a subject of a test. According to an example embodiment, the image sensor 100 may be a complementary metal-oxide semiconductor (CMOS) image sensor, but example embodiments are not restricted thereto. The tester 200 may provide a reference signal Sref to the image sensor 100 for testing the DUT, that is, the image sensor 100. In another example embodiment, the tester 200 may provide a reference signal Sref and a test signal Stest to the image sensor 100.

The image sensor 100 may transmit an output data Sout generated according to the reference signal Sref to the tester 200. In another example embodiment, the image sensor 100 may transmit an output data Sout generated according to the reference signal Sref and the test signal Stest to the tester 200. The output data Sout may be in the form of serial data.

The tester 200 is configured to receive and analyze the output data Sout, and detect a type of a defect included in the image sensor 100 and/or a location where the defect occurs based on the result of analysis. For example, the tester 200 may include an algorithm that determines a type of a defect according to a level of a specific bit included in the output data Sout, for example, a high level or low level, and detect a location where the defect occurs according to the location of the specific bit.

Detecting the type of the defect may include detecting whether or not an impedance value of a row line or column line of the image sensor 100 corresponds to the impedance value of which the image sensor 100 was designed, the row line or the column line is open, or the plurality of row lines are short circuited with each other.

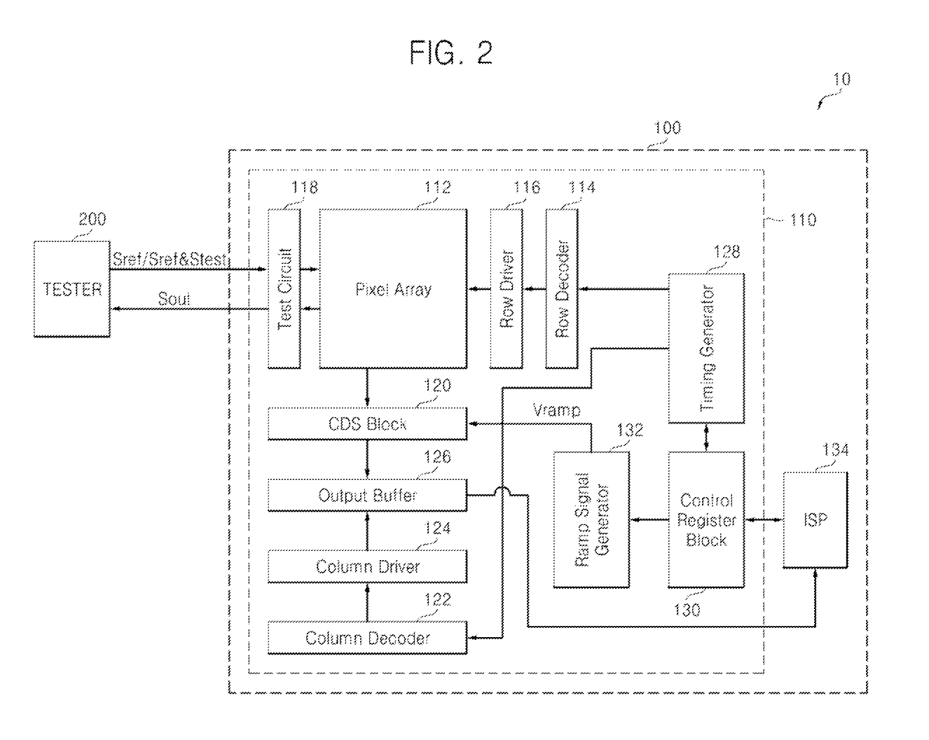

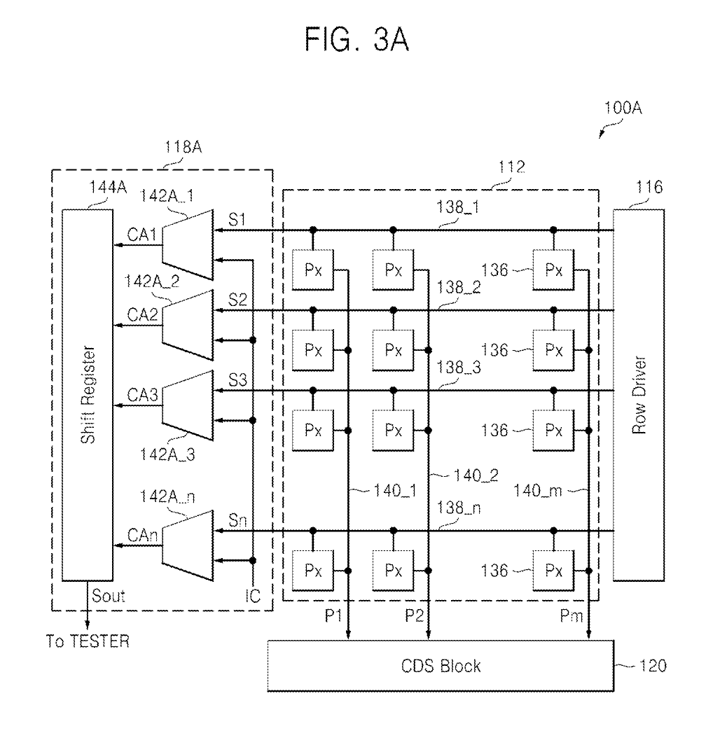

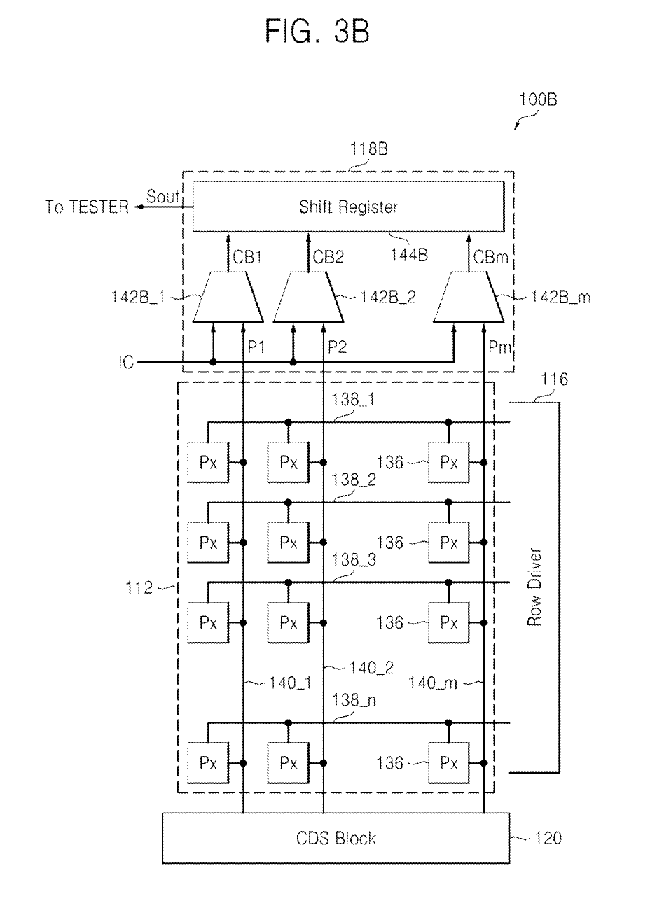

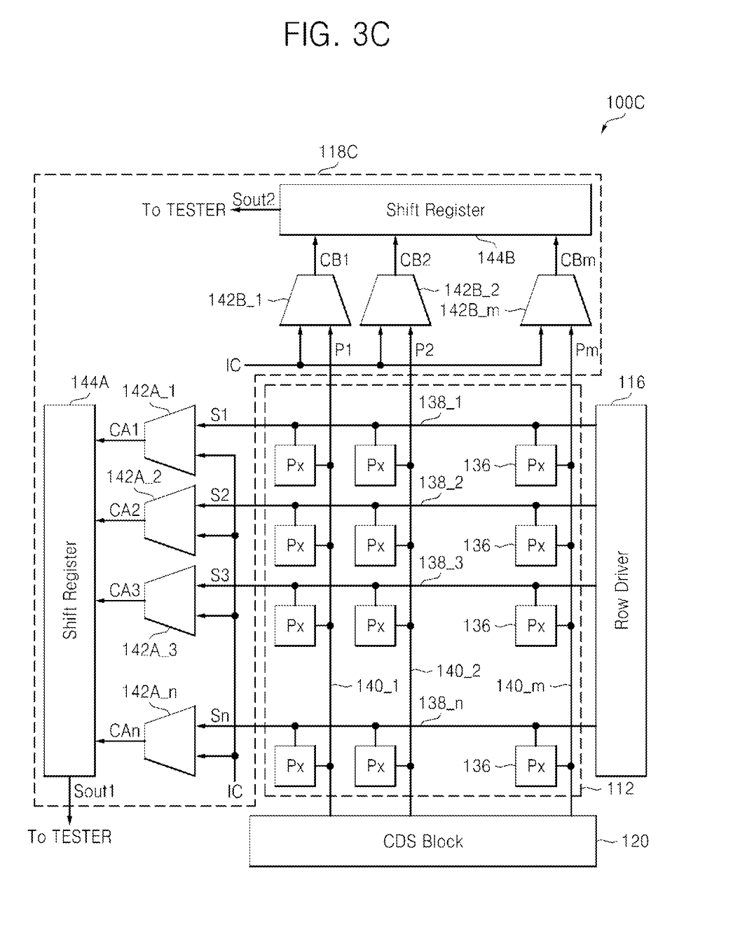

FIG. 2 is a block diagram of the example image sensor 100 shown in FIG. 1 including a test circuit 118, and FIG. 3A is a partial schematic circuit diagram of an image sensor 100A including an example embodiment of the test circuit 118A shown in FIG. 2. FIG. 2 illustrates the image sensor 100 and the tester 200 at the same time, for convenience of explanation.

Referring to FIGS. 2 and 3A, the image sensor 100 may include a signal processing circuit 110 and an image signal processor (ISP) 134. The signal processing circuit 110 and ISP 134 may be embodied into a separate chip or a module, respectively. For example, the signal processing circuit 110 and ISP 134 may be packaged into one package, for example, a multi-chip package.

The signal processing circuit 110 may generate image signals with respect to an object according to incident light.

The signal processing circuit 110 may include a pixel array 112, a row decorder 114, a row driver 116, a test circuit 118, a correlated double sampling (CDS) block 120, a column decoder 122, a column driver 124, an output buffer 126, a timing generator 128, a control register block 130, and a ramp signal generator 132.

The pixel array 112 may include a plurality of pixels 136 arranged in the form of two-dimensional matrix, and each of the plurality of pixels 136 may be connected between each of a plurality of row lines 138_1˜138_n (n is a natural number) and each of a plurality of column lines 140_1˜140_m (m is a natural number).

Each of the plurality of pixels 136 may include a photo-electric conversion element configured to convert light into an electric signal. Each of the plurality of pixels 136 may include a red pixel configured to convert light in a red spectrum region into an electric signal, a green pixel configured to convert light in a green spectrum region into an electric signal, and a blue pixel configured to convert light in a blue spectrum region into an electric signal. In some embodiments, each of the plurality of pixels 136 may include a cyan pixel, a yellow pixel, and a magenta pixel.

Each of the plurality of row lines 138_1˜138_n may be connected to a row driver 116 and configured to transmit each of a plurality of control signals S1˜Sn output from the row driver 116 into each of the plurality of pixels 136. Each of the row lines 138_1˜138_n may denote a transmission line or a plurality of transmission lines.

Each of the plurality of column lines 140_1˜140_m are configured to transmit each of the plurality of pixel signals P1˜Pm output from each of the plurality of pixels 136 to the CDS block 120. The CDS block 120 may include a readout circuit configured to readout pixel signals P1˜Pm.

The row decoder 114 is configured to receive and decode row control signals (for example, row address signals) output from a timing generator 128. The row driver 116 may drive at least a row line among the plurality of row lines 138_1′˜138_n included in a pixel array 112 in response to the decoded row control signals.

The test circuit 118 may receive a reference signal Sref output from the tester 200 and transmit an output data Sout including information about a defect which was generated in at least one of row lines 138_1˜138_n included in the pixel array and/or at least one of column lines 140_1˜140_m, for example, information about a defect type or a location where a defect occurs, to the tester 200. In another example embodiment, the test circuit 118 may receive a reference signal Sref and a test signal Stest from the tester 200.

The CDS block 120 may perform a correlated double sampling with respect to each pixel signal P1˜Pm output from each unit pixel 136 connected to each column line 140_1˜140_m included in the pixel array 112. In some embodiments, the CDS block 120 may convert an analog signal correlated double sampled into a digital signal based on a ramp signal Vramp output from a ramp signal generator 132.

The column decoder 122 may decode a plurality of column control signals, for example, column address signals, output from the timing generator 128, and may output a plurality of select signals based on the result of the decoding. Each of the plurality of select signals is used as a signal to select each of the column lines 140_1˜140_m.

The column driver 124 may drive each of the column lines 140_1˜140_m included in the pixel array 112 in response to each of the select signals output from the column decoder 122.

The output buffer 126 may buffer signals output from the CDS block 120 in response to the select signals output from the column driver 124 and transmit the buffered signals to the ISP 134.

The timing generator 128 may generate at least a control signal for controlling at least one operation of the row decoder 114, CDS block 120, column decoder 122, output buffer 126, and ramp signal generator 132 based on a command output from the control register block 130.

The control register block 130 may generate various kinds of commands to control the timing generator 128 and the ramp signal generator 132 included in the signal processing circuit 110. The ramp signal generator 132 may output a ramp signal Vramp into the CDS block 120 in response to the command output from the control register block 130. The ISP 134 may process an image of an object by processing pixel signals output from the signal processing circuit 110.

FIG. 3A is a partial schematic circuit diagram of an image sensor 100A including an example embodiment of the test circuit shown in FIG. 2. The image sensor 100A may include a test circuit 118A, a pixel array 112, a row driver 116, and a CDS block 120.

The test circuit 118A may include a plurality of comparators 142A_1˜142A_n and a shift register 114A.

A first input terminal of each of the comparators 142A_1˜142A_n are configured to receive each of a plurality of control signals S1 through Sn input through a plurality of row lines 138_1˜138_n, and a second input terminal of each of the comparators 142A_1˜142A_n are configured to receive a reference signal Sref, for example, a reference current IC output from a tester 200.

Each of the comparators 142A_1˜142A_n may compare each of the control signals S1 through Sn transmitted through each of the row lines 138_1˜138_n with the reference signal Sref, for example, the reference current IC, and output each comparative signal CA1˜Can based on the result of the comparison.

The shift register 144A is configured to convert each of the comparative signals CA1˜CAn output from each of the comparators 142A_1˜142A_n, that is, parallel data, into an output data Sout, that is, serial data. The output data Sout output from the shift register 144A may be transmitted into the tester 200. The comparators 142A_1˜142A_n and the shift register 144A may be embodied in the opposite side of the row driver 116, but example embodiments are not restricted thereto.

The shift register 144A may be used as an example of a data converter for converting a parallel data into a serial data.

Each of the comparators 142A_1˜142A_2 may be embodied into a current comparator or voltage comparator.

FIG. 3B is a partial schematic circuit diagram an image sensor including another example embodiment of the test circuit shown in FIG. 2. Referring to FIG. 3B, the image sensor may include the test circuit 118B, a pixel array 112, a row driver 116, and a CDS block 120.

The test circuit 118B may include a plurality of comparators 142B_1˜142B_m and a shift register 144B.

A first input terminal of each of the comparators 142B_1˜142B_m may receive each pixel signal P1˜Pm transmitted through each column line 140_1˜140m, and a second input terminal of each of the comparators 142B_1˜142B_m may receive a reference signal Sref, for example, a reference current IC, output from a tester 200. Each of the comparators 142B_1˜142B_m may compare each pixel signal P1 through Pm transmitted through each column line 140_1˜140_m with the reference signal Sref, for example, the reference current IC and output each comparative signal CB1˜CBm based on the result of the comparison.

The structure and the operation of a shift register 144B shown in FIG. 3B may be substantially identical to the structure and the operation of the shift register 144A of FIG. 3A. In some embodiments, a switch (not shown) may be embodied between each column line 140_1 through 140_m and the CDS block 120. As shown in FIG. 3B, the test circuit 118B may be embodied at the opposite site of the CDS block 120, but example embodiments are not restricted thereto.

FIG. 3C is a partial schematic circuit diagram of an image sensor including yet another example embodiment of the test circuit shown in FIG. 2. Referring to FIG. 3C, the image sensor 100C may include a test circuit 118C, a pixel array 112, a row driver 116, and a CDS block 120.

The test circuit 118C of FIG. 3C may test defects of row lines 138_1˜138_n and/or column lines 140_1 through 140_m at the same time.

Referring to FIG. 2, FIG. 3A, FIG. 3B, and FIG. 3C, the test circuit 118C includes a plurality of first comparators 142A_1˜142A_n, a plurality of second comparators 142B_1˜142B_m, a first shift register 144A, and a second shift register 144B.Output signals Sout1 of the first shift register 144A and output signals Sout2 of the second sift register 144B may be output sequentially into a tester 200 as an output data Sout. Thus, the tester 200 may detect a type of a defect generated in row lines 138_1˜138_n and a location where the defect occurs by analyzing the output signals Sout1 of the first shift register 144A and a type of a defect generated in column lines 140_1˜140_m and a location where the defect occurs by analyzing output signals Sout2 of the second shift register 144B.

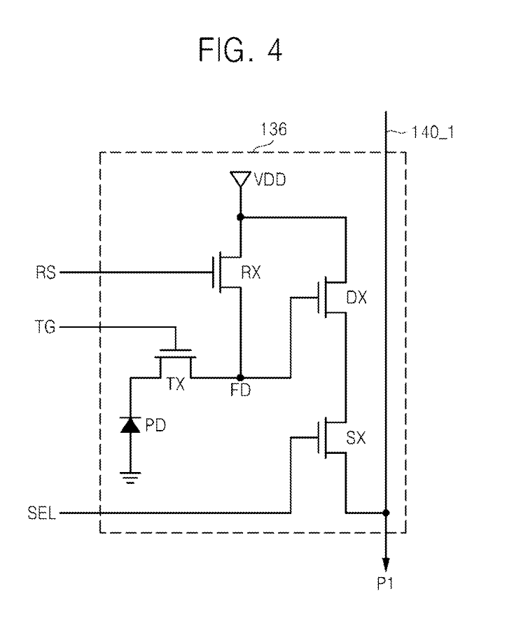

FIG. 4 is a circuit diagram according to an example embodiment of the pixel 136 shown in FIGS. 3A through 3C. Referring to FIGS. 3A through 4, each of the pixels 136 includes a photo diode PD and four transistors TX, RX, DX, and SX.

The photo diode is configured to generate photo charges according to the incident light. The transfer transistor TX is configured to transmit the photo charges generated in the photo diode PD into a floating diffusion region FD in response to a transmitting control signal TG. The reset transistor RX is configured to reses the floating diffusion region FD in response to a reset signal RS. The drive transistor DX is configured to perform a function of source follower buffer amplifier operating in response to the voltage of the floating diffusion region FD.

The select transistor SX is configured to transmit a pixel signal P1 corresponding to the photo charges generated in the photo diode PD to the first column line 140_1 in response to a select signal SEL. Each of the control signals Si though Sn transmitted though each row line 138_1˜138_n may be a transmitting control signal TG, reset signal RS, or select signal SEL.

FIG. 4 illustrates the pixel 136 including a photo diode PD and four transistors TX, RX, DX, and SX, for convenience of explanation, however the pixel 136 may be embodied into a pixel including a photo diode and three transistors, a photo diode and five transistors, a pixel having a photogate structure, and so on.

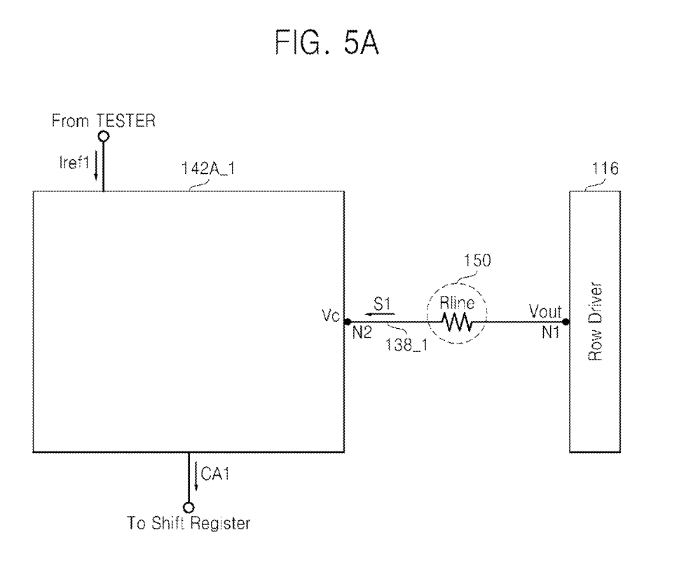

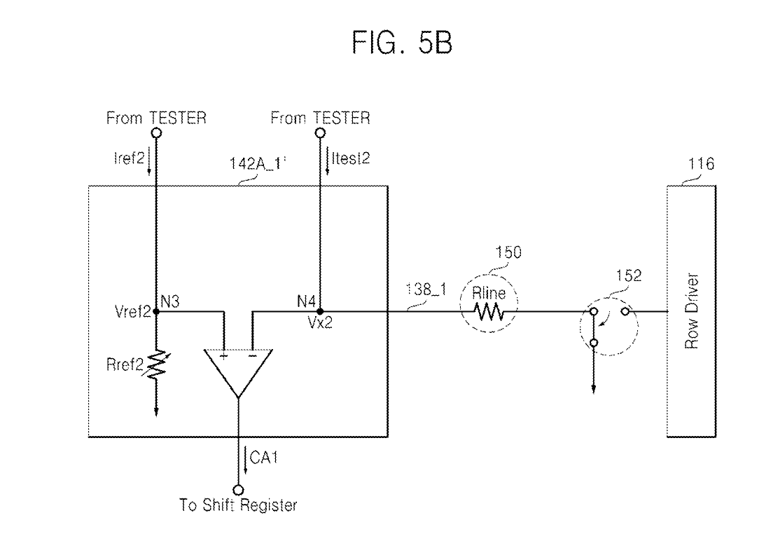

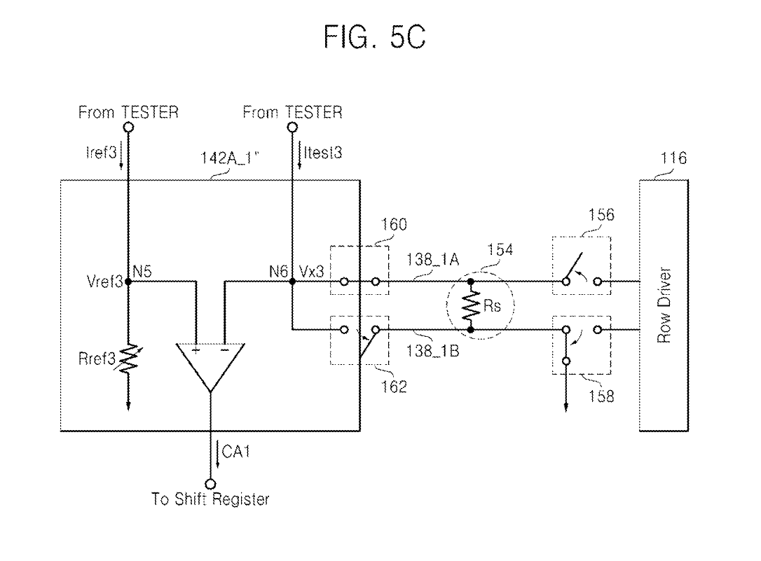

FIG. 5A is a partial schematic circuit diagram of an image sensor including one of the comparators 142A_1˜142A_n shown in FIG. 3A. Each structure of the comparators 142A_1˜142A_n is identical with each other, therefore, the operation of the first comparator 142A_1 will be described in detail referring to FIGS. 3A and 5A for convenience of explanation.

The first comparator 142_1 may test whether a first row line 138_1 has a defect or not by using a first control signal S1 transmitted through the first row line 138_1.

A line resistor 150 is a modeling of resistance component of the first row line 138_1. Vout is a potential or voltage of an output node N1 of a row driver 116, and Vc is a potential or voltage of an input node N2 of the first comparator 142A_1. As a first control signal S1 flows through the line resistor 150, there occurs a potential difference Vout-Vc between the output node Ni and the input node N2.

A first reference current Iref1 of the reference signal Sref output from a tester 200, may be set to be equal to a current value of the first control signal S1. When the resistance value Rline of the line resistor 150 of the first row line 138_1 is equal to the designed resistance value within the limits of error, the first row line 138_1 may be said not to have a defect.

Therefore, the first comparator 142A_1 may compare the first reference current Iref1 with the first control signal SI, generate a first comparative signal CA1 according to the result of the comparison, and transmit the generated first comparative signal CA1 into a shift resister 144A.

The tester 200 may confirm whether the resistance value Mine of the line resistor 150 is different from the designed resistance value or not according to the level of the first comparative signal transmitted from the shift resistor 144A. In other words, the tester 200 may test whether the first row line 138_1 has a defect or not according to the level of the first comparative signal CA1.

FIG. 5B is a partial schematic circuit diagram of an image sensor including another example embodiment of one of the comparators 142A_1˜142A_n shown in FIG. 3A. Referring to FIGS. 1, 3A, and 5B, a first comparator 142A_1′ may test a first row line 138_1 by using a test signal Stest output from a tester 200, for example, a test current Itest2.

A switch 152 may selectively connect the first row line 138_1 into a row driver 116 or a ground in response to a switching signal. The tester 200 may provide a reference signal Sref, for example, a second reference current Iref2, and a test signal, for example, a test current Itest2, to the first comparator 142A_1′ for testing whether the first row line 138_1 has a defect or not.

The second reference current Iref2 flows to the ground through a node N3 and a reference resistor Rref2. At this time, a potential Vref2 of the node N3 corresponds to the multiplication of the second reference current Iref2 and the reference resistor Rref2.

When the first row line 138_1 and the ground are connected through the switch 152, the test current Itest2 flows to the ground through a node N4 and a line resistor 150 of the first row line 138_1. At this time, a potential Vx2 of the node N4 corresponds to the multiplication of a test current Itest2 and a resistance value Rline the line resistor 150. In some embodiments, the second reference current Iref2 and the test current Itest2 may have an equal value.

The first comparator 142A_1′ is configured to compare the potential Vref2 of the node N3 with the potential Vx2 of the node N4, generate a first comparative signal CA1 according to the result of the comparison, and transmit the generated first comparative signal CA1 into a shift resistor 144A. At this time, the first comparative signal CA1 may be a high level or low level.

For example, when the level of the first comparative signal CA1 is low, that is, the potential Vx2 of the node N4 is higher than the potential Vref2 of the node N3, the tester 200 may determine that the resistance value Rline of the line resistor 150 of the first row line 138_1 is higher than the designed resistance value. That is, the tester 200 may determine a type of a defect and a location where the defect occurs according to the level of the first comparative signal CAL

When the level of the first comparative signal CA1 is high, that is, the potential Vx2 of the node N4 is lower than the potential Vref2 of the node N3, the tester 200 may determine that the resistance value mine of the line resister 150 of the first row line 138_1 is lower than the designed resistance value. That is, the tester 200 may determine a type of a defect and a location where the defect occurs according to the level of the first comparative signal CA1.

FIG. 5C is a partial schematic circuit diagram of an image sensor including yet another example embodiment of one of the comparators shown 142A_1˜142A_n in FIG. 3A. Referring to FIGS. 1, 3A, 4, and 5C, a first comparator 142_A1″ may test a defect of a first transmission line 138_1A and a second transmission line 138_1B by using a test current Itest 3.

Each of the first transmission line 138_1A and the second transmission line 138_1B may be a transmission line for transmitting a transmission control signal TG, a reset signal RS, or select signal SEL. And, each of the first transmission line 138_1A and the second transmission line 138_1B may be a transmission line in a different row.

The first comparator 142A_ A1″ may test whether the first transmission line 138_1A and the second transmission line 138 1B are short circuited or not.

For example, the tester 200 may provide a reference signal Sref, for example, a third reference current Iref3, and a test signal Stest, for example, a test current Itest3, to the first comparator 142A_1″ to test whether the first row line 138_1 has a defect or not.

A short resistor 154 represents a resistance component between the first transmission line 138_1A and the second transmission line 138_1B that arises from a defect during manufacturing or a foreign substance after manufacturing.

A first switch 156 may selectively separate the first transmission line 138_1A from a row driver 116 in response to a first switching signal. A second switch 158 may selectively separate the second transmission line 138_1B from the row driver 116 in response to a second switching signal and connect the second transmission line 138_1B to a ground. A third switch 160 may selectively connect the first transmission line 138_1A to the first comparator 142A_1″ in response to a third switching signal, and a fourth switch 162 may selectively separate the second transmission line 138 1B from the first comparator 142A_1″ in response to a fourth switching signal.

The third reference current Iref3 flows to the ground through a node N5 and a third reference resistor Rref3. At this time, a potential Vref3 of the node N5 corresponds to the multiplication of the third reference current Iref3 and the reference resistor Rref3.

When there is no defect present between the first transmission line 138_1A and the second transmission line 138 1B, a resistance value Rs of the short resistor 154 is infinite, thereby a current does not flow through the first transmission line 138_1A. In other words, a potential Vx3 of a node N6 is determined by a power supply from the tester 200. At this time, the power supply from the tester 200 may be set such that the potential Vx3 of the node N6 is higher than the potential Vref3 of the node N5.

When a defect is present between the first transmission line 138_1A and the second transmission line 138_1B, the resistance value Rs of the short resistor 154 is limited, for example, 0 Ω. The third test current Itest3 flows to the ground through the first transmission line 138_1A and the short resistor 154 and the ground connection of the second transmission line 138_1B. At this time, the potential Vx3 of the node N6 corresponds to the multiplication of the third test current Itest3 and the resistance value Rs of the short resistor 154. In other words, the third test current Itest3 may be set such that the potential Vx3 of the node N6 is lower than the potential Vref3 of the node N5.

When the level of a first comparative signal CA1 is low, that is, the potential Vx3 of the node N6 is higher than the potential Vref3 of the node N5, the tester 200 may determine that no defect is present between the first transmission line 138_1A and the second transmission line 138_1B according to the level of the first comparative signal CA1.

When the level of a first comparative signal CA1 is high, that is, the potential Vx3 of the node N6 is lower than the potential Vref3 of the node N5, the tester 200 may determine that there occurs a defect between the first transmission line 138_1A and the second transmission line 138_1B according to the level of the first comparative signal CAL That is, the tester 200 may determine that the first transmission line 138_1A and the second transmission line 138_1B are short with each other.

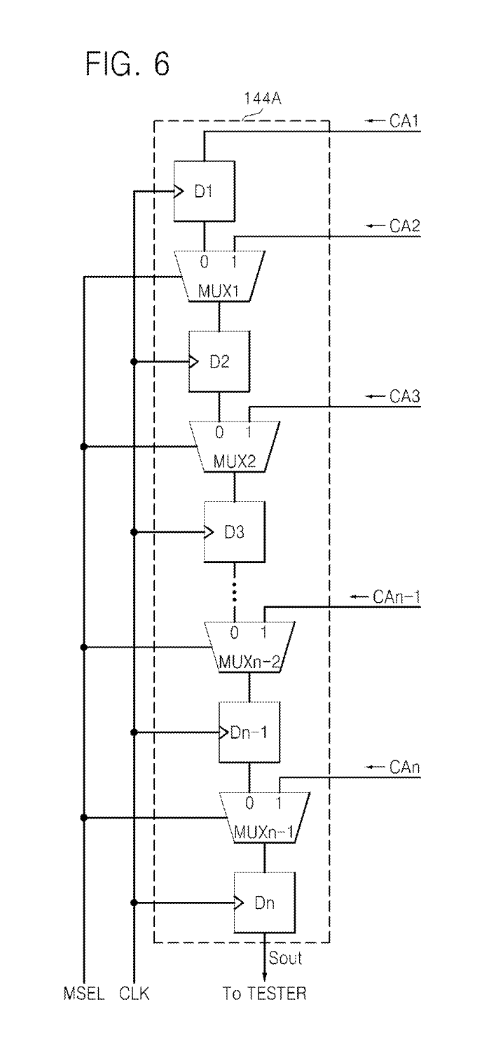

FIG. 6 is a block diagram of the shift register 144A shown in FIG. 3A. Referring to FIGS. 3A and 6, the shift register 144A includes a plurality of latches D1˜Dn and a plurality of multiplexers MUX1˜MUXn−1.

Each latch D1˜Dn is configured to latch each comparative signal CA1˜CAn output from each comparator 142A_1-˜142A_n in response to a clock signal CLK. In some embodiments, each of the latches D1˜Dn may be embodied as a D flip-flop, but example embodiments are not restricted thereto.

Each multiplexer MUX1˜MUXn−1 may be connected between two adjacent latches D1 and D2, D2 and D3, . . . Dn. Each multiplexer MUX1˜MUXn−1 is configured to output an output signal or each of the comparative signals CA1 through CAn of the previous latch D1˜Dn−1 to the next latch D2˜Dn according to the level of a select signal MSEL.

For example, when the select signal MSEL is logic 1 or high level, each of the multiplexers MUX1˜MUXn−1 may output each of the comparative signals CA1 through CAn into the next latch D2˜Dn. However, when the select signal MSEL is logic 0 or low level, each of the multiplexer MUX1˜MUXn−1 may output an output signal of each of the previous latch D1˜Dn−1 into the next latch D2˜Dn.

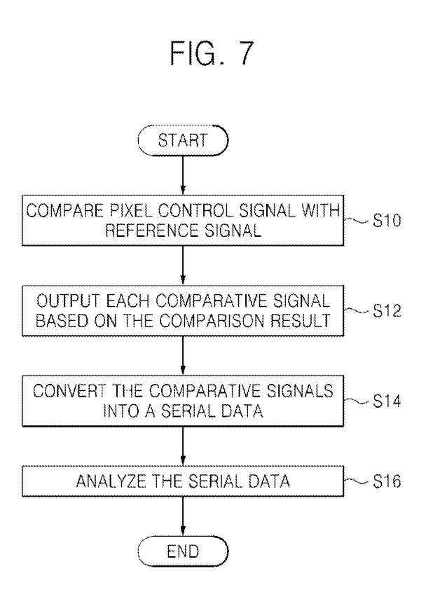

FIG. 7 is a flow chart of a method for testing an image sensor according to an example embodiment of the inventive concepts. Referring to FIGS. 1, 3A, 5A, 6, and 7, the first comparator 142A_1 is configured to compare the first reference current Iref1 of the reference signal Sref and the first control signal S1 provided as a pixel control signal (S10).

Each comparator 142A_2˜142A_n is configured to output each comparative signal CA2 through Can (S12). For example, the first comparator 142A_1 is configured to output the first comparative signal CA1 according to the result of the comparison. The shift register 144A is configured to convert the plurality of comparative signals CA1˜CAn, that is, parallel data, into an output data Sout, that is, serial data, and output the serial data into the tester 200 (S14). The tester 200 is configured to receive and analyze the output data Sout, and may determine a type of a defect occurring in the image sensor 100 and/or a location where the defect is occurring (S16).

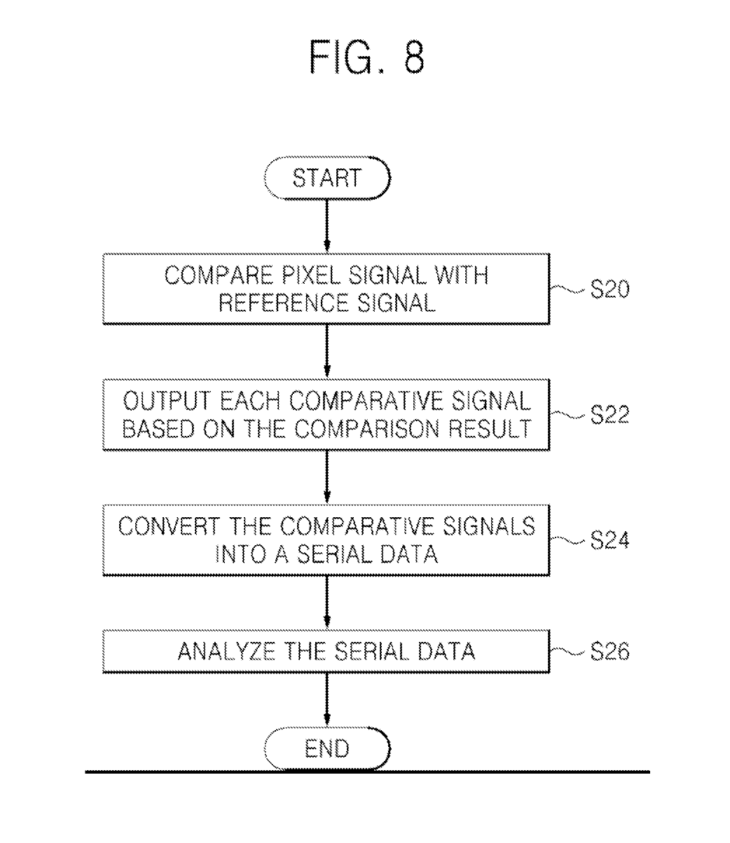

FIG. 8 is a flow chart of a method for testing an image sensor according to another example embodiment of the present invention. Referring to FIGS. 1, 3B, 5A, 6, and 8, each of the comparators 142B_1˜142B_m is configured to compare the reference signal Sref, for example, the reference current IC, and each of the pixel signals P1 through Pm with each other (S20).

Each step of S22, S24 and S26 shown in FIG. 8 is identical to each step of S12, S14, and S16 shown in FIG. 7, therefore, for the sake of brevity descriptions thereof are omitted here.

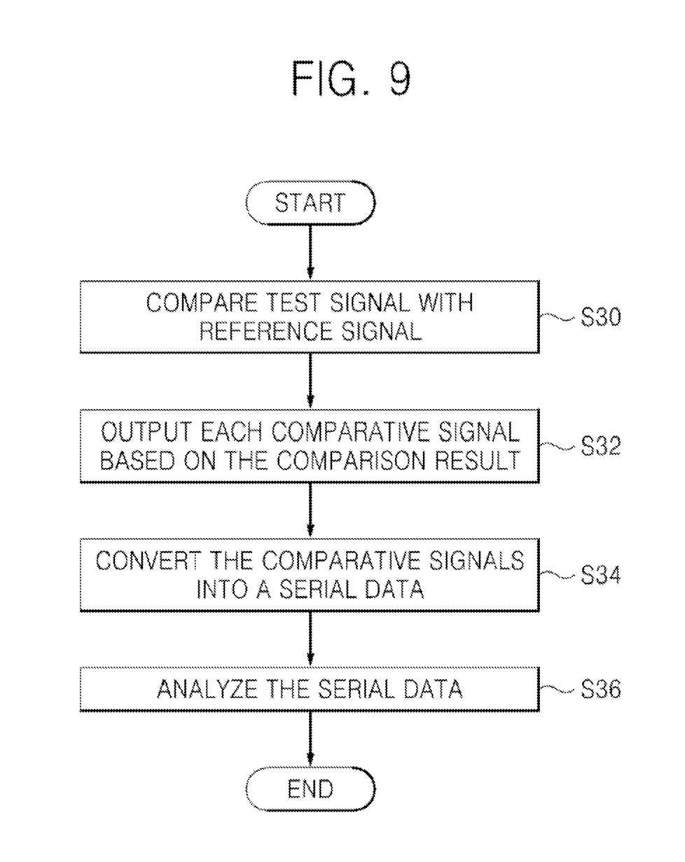

FIG. 9 is a flow chart of a method for testing an image sensor according to yet another example embodiment of the present inventive concepts.

Referring to FIGS. 1, 5B, 5C, 6, and 9, the first comparator 142A_1′ is configured to compare the reference signal Sref, for example, the potential Vref2 of the node N3 which is determined by the second reference current Iref2, and the test signal Stest, for example, the potential Vx2 of the node N4 which is determined by the test current Itest2, with each other (S30).

The first comparator 142A_1″ of FIG. 5C may compare the reference signal Sref, for example, the potential Vref3 of the node N5 which is determined by the third reference current Iref3 and the test signal Stest, for example, the potential Vx3 of the node N6 which is determined by the third test current Itest3 with each other (S30).

Each step of S32, S34, and S36 shown in FIG. 9 is identical to each step of S12, S14, and S16 shown in FIG. 7, therefore, descriptions thereof are omitted here.

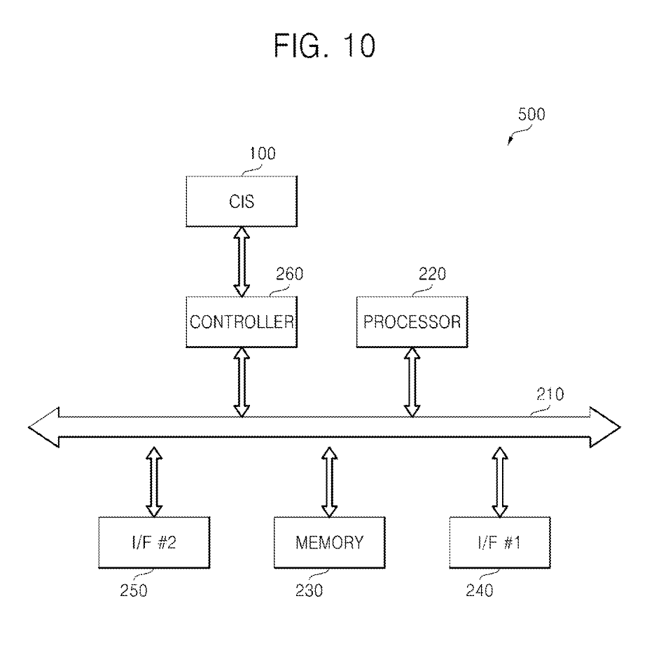

FIG. 10 is a block diagram of an image processing apparatus 500 including the image sensor 100 of FIG. 1. Referring to FIG. 1 and FIG. 10, the image processing apparatus 500 also referred to as an image pick-up device includes a processor 220 which is connected to a system bus 210, a memory 230, a first interface 240, a second interface 250, a controller 260, and a CMOS image sensor 100 which is controlled by a controller 260.

The processor 220 is configured to control the general operation of the image processing apparatus 500. The processor 220 is configured to control the operation of the controller 260 by communicating with the controller 260.

The controller 260 may control the image sensing operation and the processing operation of the image sensor 100 by communicating with the control register block 130 and at least one operation of the signal conversion operation, for example, the co-related double sampling operation and analog-digital conversion operation. The processor 220 may control the data write operation or the data read operation of the memory 230. The memory 230 may store an image data processed by the CMOS image sensor 100.

The first interface 240 may be embodied into an input/output interface. The processor 220 may control the operation of reading data stored to the memory 230 and transmit the data to the outside through the first interface 240 or the operation of storing data input from the outside through the first interface 240 to the memory 230. For example, the first interface 240 may be a display controller capable of controlling the operation of a display. Thus, the display controller may transmit data processed by the CMOS image sensor 100 to the display under the control of the processor 220.

The second interface 250 may be embodied into a wireless interface. The processor 220 may control the operation of reading data stored to the memory 230 and transmit the data to the outside through the second interface 250 by wireless or the operation of storing data input from the outside through the second interface 250 by wireless.

The image processing apparatus 500 may be embodied into a portable application including the CMOS image sensor. The portable application may be embodied as portable computer, digital camera, mobile phone, smart phone, or tablet PC.

The apparatus according to example embodiments of the present inventive concepts has an effect of self-testing a defect of a row line or column line by connecting comparators to the row line or column line. Also, the apparatus has the effects of shortening a time required for testing a defect of the row line or column line and self-determining a type of the defect.

Although while example embodiments have been particularly shown and described with reference to example embodiments thereof, it will be understood by those of ordinary skill in the art that various changes in forms and details may be made therein without departing from the spirit and scope of example embodiments as defined by the following claims.

1. An image sensor comprising:
a plurality of pixels configured to be controlled by a plurality of control signals;
a plurality of transmission lines connected to each of the pixels, respectively; and
a plurality of comparators configured to compare each of the control signals transmitted through each of the transmission lines with a reference signal and output a comparative signal according to the result of the comparison.

2. The image sensor of claim 1, further comprising:
a row driver configured to output each of the control signals, and wherein the plurality of comparators are embodied at an opposite side of the row driver.

3. The image sensor of claim 1, further comprising:
a row driver configured to output each of the control signals; and
a plurality of switches each connected between each of the transmission lines and the row driver.

4. The image sensor of claim 3, wherein the image sensor further comprises:
a data converter configured to convert comparative signals output from the plurality of comparators into serial data.

5. The image sensor of claim 1, wherein the transmission lines are column lines configured to transmit pixel signals output from the pixels.

6. The image sensor of claim 1, wherein the plurality of comparators are current comparators.

7. The image sensor of claim 1, wherein each control signal is one of a transmission control signal, reset signal, and select signal.

8. The image sensor of claim 1, wherein the image sensor further comprising:
a plurality of latches; and
a plurality of selectors, wherein a present selector among the plurality of selectors is configured to transmit one of (1) an output signal of a previous latch among the plurality of latches to a next latch of the plurality of latches in response to a select signal, and (2) a comparative signal output from the comparator corresponding to the present selector among the comparators to the next latch in response to the select signal.

9. An image processing apparatus comprising:
an image sensor including,
a plurality of pixels each configured to be controlled by an associated control signal,
a plurality of transmission lines each connected to an associated pixel and configured to transmit the associated control signal, and
a plurality of comparators each configured to compare the associated control signal with a reference signal and output a comparative signal based on the result of the comparison; and
a controller configured to control the image sensor.

10. The image processing apparatus of claim 9, wherein each of the transmission lines is a row line configured to transmit the associated control signal.

11. The image processing apparatus of claim 9, further comprising:
a row driver configured to output the control signals, each control signal being one of a transmission control signal, reset signal, and select signal.

12. The image processing apparatus of claim 9, wherein the transmission lines are column lines configured to transmit pixel signals output from the pixels.

13. The image processing apparatus of claim 9, wherein the image sensor further includes:
a shift register connected to an output terminal of each comparator of the plurality of comparators.

14. The image processing apparatus of claim 9, wherein the image sensor further comprises:
a plurality of latches; and
a plurality of selectors, wherein a present selector among the plurality of selectors is configured to transmit one of an output signal of a previous latch among the plurality of latches to the a next latch of the plurality of latches in response to a select signal, and a comparative signal output from the comparator corresponding to the present selector among the comparators to the next latch in response to the select signal.

15. A portable communication device comprising:
the image processing apparatus of claim 9;
a processor configured to control an operation of the image processing apparatus; and
a display configured to display data output from the image processing apparatus.
